(19) United States
(12) Patent Application Publication
(10) Pub. No.: US 2024/0129823 A1
(43) Pub. Date: Apr. 18, 2024

(54) RADIO COMMUNICATION SYSTEM, BASE STATION APPARATUS, NW CONTROL APPARATUS AND CONNECTION CONTROL METHOD

(71) Applicant: NIPPON TELEGRAPH AND TELEPHONE CORPORATION, Tokyo (JP)

(72) Inventors: Takeru FUKUSHIMA, Tokyo (JP); Motoharu SASAKI, Tokyo (JP); Toshiro NAKAHIRA, Tokyo (JP); Daisuke MURAYAMA, Tokyo (JP); Takatsune MORIYAMA, Tokyo (JP)

(73) Assignee: NIPPON TELEGRAPH AND TELEPHONE CORPORATION, Tokyo (JP)

(21) Appl. No.: 18/278,776

(22) PCT Filed: Feb. 26, 2021
(86) PCT No.: PCT/JP2021/007468

§ 371 Date: Aug. 24, 2023

(51) Int. Cl. H04W 36/14; H04W 36/30

(52) U.S. Cl. CPC H04W 36/14; H04W 36/30

(57) ABSTRACT

A wireless communication system comprising a plurality of base station devices including a first base station device and a second base station device, wherein the first base station device connected with a terminal determines whether to continue connection with the terminal or not on a basis of a communication quality requirement of the terminal and a resource that can be provided to the terminal, and the first base station device transmits a control signal instructing connection with the second base station device to the terminal in a case where the first base station device determines not to continue the connection with the terminal.

### TECHNICAL FIELD

The present invention relates to a technology for connecting a terminal with an appropriate base station in a wireless communication system including a terminal and a base station.

### BACKGROUND ART

Examples of a wireless communication system including a terminal and a base station are 5G wireless access systems disclosed in Non Patent Literatures 1 to 4, for example. A 5G wireless access system is an example of a cellular system, and LTE, 3G, and the like are widely used in cellular systems in addition to 5G. Moreover, a wireless LAN is also widely used as a wireless communication system including a terminal and a base station.

In an environment where a plurality of wireless communication systems exist, a terminal generally determines a connection destination on the basis of received power. For example, in an environment where both a cellular system and a wireless LAN exist, the terminal is connected with the wireless LAN when the received signal strength from the wireless LAN base station is equal to or larger than a threshold value, and is connected with the cellular system when the received signal strength from the wireless LAN base station is equal to or smaller than a threshold value and the received signal strength from the cellular base station is equal to or larger than a threshold value.

### CITATION LIST

### Non Patent Literature

Non Patent Literature 1: DOCOMO Technical Journal, Vol. 23, No. 4, pp. 18-29, 2020
Non Patent Literature 2: DOCOMO Technical Journal, Vol. 28, No. 3, pp. 82-95, 2020
Non Patent Literature 3: DOCOMO Technical Journal, Vol. 26, No. 3, pp. 74-88, 2018
Non Patent Literature 4: 3GPP TS 38.133. “NR; Requirements for support of radio resource management.” 3rd Generation Partnership Project; Technical Specification Group Radio Access Network.

### SUMMARY OF INVENTION

### Technical Problem

In an environment where a plurality of wireless systems exist, an accommodation destination is determined regardless of a communication quality that can be provided by the wireless communication system, in a case where a connection destination is determined on the basis of received power.

For example, in a case where a terminal selects a connection destination base station by a conventional method in an environment where both a cellular system and a wireless LAN exist, even if there are abundant resources of the cellular system, the terminal is connected with a wireless LAN when the received signal strength of the wireless LAN is equal to or larger than a threshold, and thus, the resources of the wireless LAN may be depleted first and the communication quality required by the terminal may not be provided.

The present invention has been made in view of the above points, and an object thereof is to provide a technology that enables connection of a terminal with an appropriate base station according to the communication quality required by the terminal in a wireless communication system.

### Solution to Problem

According to the disclosed technology, there is provided a wireless communication system including a plurality of base station devices including a first base station device and a second base station device, in which the first base station device connected with a terminal determines whether to continue connection with the terminal or not on the basis of a communication quality requirement of the terminal and a resource that can be provided to the terminal, and the first base station device transmits a control signal instructing connection with the second base station device to the terminal in a case where the first base station device determines not to continue the connection with the terminal.

### Advantageous Effects of Invention

According to the disclosed technology, there is provided a technology that enables connection of a terminal with an appropriate base station according to the communication quality required by the terminal in a wireless communication system.

### BRIEF DESCRIPTION OF DRAWINGS

FIG. 1 is a configuration diagram of a communication system according to Example 1.

FIG. 2 is a configuration diagram of a terminal.

FIG. 3 is a configuration diagram of a wireless LAN base station.

FIG. 4 is a configuration diagram of a cellular base station.

FIG. 5 is a sequence diagram for explaining an operation example of a communication system in Example 1-1.

FIG. 6 is a sequence diagram for explaining an operation example of a communication system in Example 1-2.

FIG. 7 is a sequence diagram for explaining an operation example of a communication system in Example 1-3.

FIG. 8 is a configuration diagram of a communication system according to Example 2.

FIG. 9 is a configuration diagram of an NW controller.

FIG. 10 is a sequence diagram for explaining an operation example of a communication system according to Example 2.

FIG. 11 is a diagram illustrating a processing flow in Example 3-1.

FIG. 12 is a diagram illustrating a processing flow in Example 3-2.

FIG. 13 is a diagram illustrating a processing flow in Example 3-2.

FIG. 14 is a diagram illustrating a hardware configuration example of a device.

FIG. 15 is a diagram for explaining an effect.

### DESCRIPTION OF EMBODIMENTS

Hereinafter, an embodiment of the present invention (this embodiment) will be described with reference to the drawings. The embodiment described below is merely an example, and an embodiment to which the present invention is applied is not limited to the following embodiment.

(Overview of Embodiment)

In this embodiment, the connection is controlled on the basis of the communication quality or the like provided to each terminal by the base station, in order to enable connection of the terminal with an appropriate base station according to the communication quality required by the terminal.

Specifically, the satisfaction level or the sufficiency level is calculated on the basis of the communication quality needed by each terminal and the communication quality provided to each terminal by each base station, and control such as selection of a connection destination base station of the terminal is performed. Note that the “communication quality provided to a terminal” by the base station is the “communication quality that can be provided to the terminal” in the case of a terminal before communication, or the “communication quality actually provided to the terminal” in the case of a terminal in communication after connection establishment.

A base station or an NW controller to be described later performs connection control for each terminal by using a satisfaction level or a sufficiency level with a quantitative communication quality of each terminal.

The above communication quality is not limited to a specific one, but for example, a throughput [Mbps], a communication delay [s], a packet loss rate [%], or the like can be used.

A time slot that is a time (period) during which the base station or the NW controller evaluates a communication quality such as a throughput and a packet loss rate may also be changed according to the requirement of the user (terminal).

That is, since grasping of the quality with high frequency leads to an increase in communication overhead, for example, time slots for grasping the communication quality may be dynamically controlled according to the quality requirement of the user such that quality degradation can be quickly detected by grasping the quality in a short period in a case where the quality requirement of the user is high, and the communication quality is grasped in a relatively long period of time with communication quality degradation to some extent regarded as an allowable range in a case where the quality requirement of the user is low.

In this embodiment, in an environment where a plurality of base stations capable of communicating with a terminal are arranged, the terminal is connected with a base station that can satisfy the quality requirement of the terminal on the basis of, for example, the following information (1) to (4).
(1) Communication Quality Required by Terminal (More Specifically, Communication Session of Terminal)

The above communication quality may be a quality in communication of one of the DL and the UL, or may be a quality in communication of both the DL and the UL.
(2) Communication Quality with which Wireless Communication Link Between Terminal and Base Station can be Implemented
(3) Communication Quality that can be Provided by Base Station
(4) Priority Order of Controlling Terminal that Performs Communication

Regarding a priority order setting method, for example, the priority order is set higher as the communication quality requirement is lower in a case where the number of terminals accommodated in a base station is prioritized. Moreover, the priority order may be set in the order of connection. Moreover, the priority order may be set on the basis of the contract form of the user. For example, in a contract form, control is preferentially performed on a terminal for which a “high priority” contract has been made.

Hereinafter, Examples 1 to 3 will be described as more specific operation examples. Note that, although an example in which a base station (which will be referred to as a wireless LAN base station) in a wireless LAN system and a base station (which will be referred to as a cellular base station) in a cellular system exist is described as an example of an environment where a plurality of base stations exist, this is an example. For example, a plurality of base stations may be base stations in a plurality of types of cellular systems (e.g., LTE, 5G, and 3G). Moreover, although DL communication is mainly assumed below, similar control can be performed in UL communication.

### Example 1

<System Configuration>

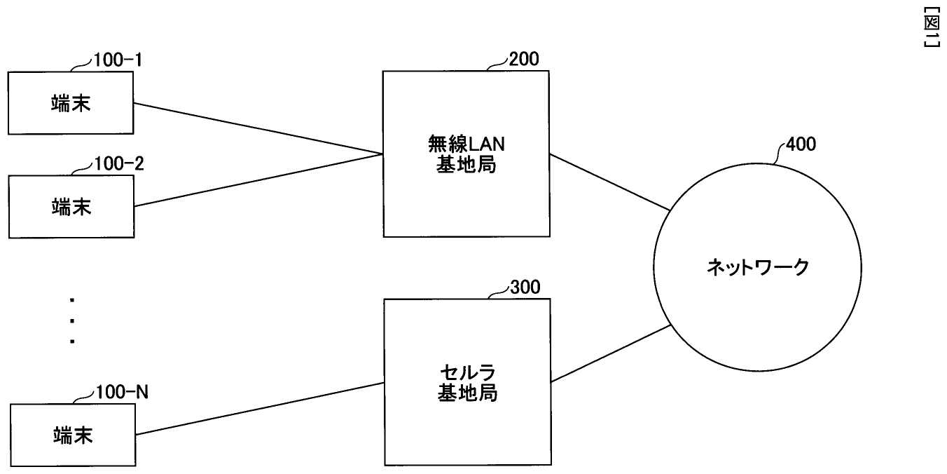

FIG. 1 illustrates an overall configuration example of a communication system according to Example 1. As illustrated in FIG. 1, the communication system includes a plurality of terminals 100-1 to 100-N, a wireless LAN base station 200, and a cellular base station 300. The wireless LAN base station 200 and the cellular base station 300 are connected with a network 400. The network 400 is, for example, a network in which a server that provides a service of an application used by the terminal 100 exists. Moreover, it is assumed here that any terminal can communicate with the wireless LAN base station 200 and the cellular base station 300 (received signal strength equal to or higher than a threshold). Note that the terminal may be referred to as a terminal device, and the base station may be referred to as a base station device.

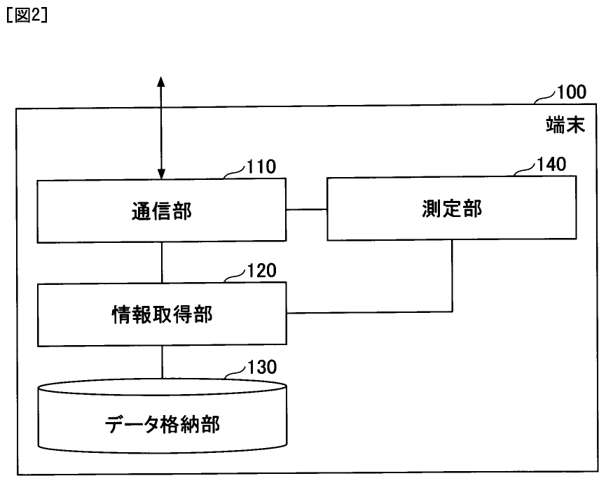

FIG. 2 illustrates a configuration example of the terminal 100. As illustrated in FIG. 2, the terminal 100 includes a communication unit 110, an information acquisition unit 120, a data storage unit 130, and a measurement unit 140. The communication unit 110 performs wireless communication with a base station. Moreover, an application is installed in the communication unit 110, and data communication with a server or the like by the application is performed. The measurement unit 140 measures the quality of a wireless communication link.

The information acquisition unit 120 acquires a communication quality requirement in a use application, a measurement result by the measurement unit 140, and the like, and transmits the communication quality requirement, the measurement result, and the like via the communication unit 110. The data storage unit 130 stores, for example, wireless communication standard information or the like supported by the terminal 100.

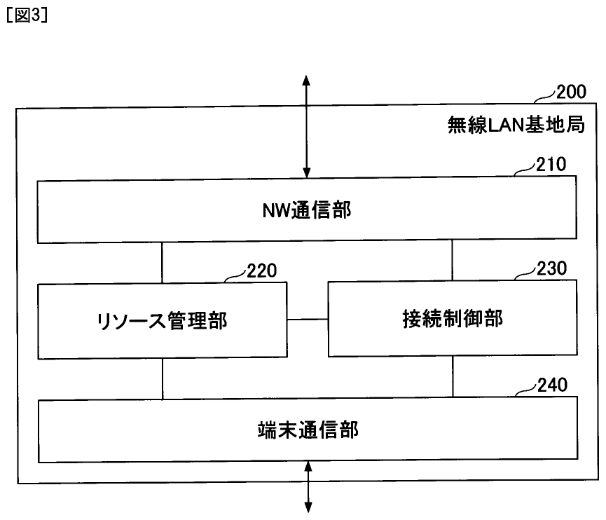

FIG. 3 illustrates a configuration example of the wireless LAN base station 200. As illustrated in FIG. 3, the wireless LAN base station 200 includes an NW communication unit 210, a resource management unit 220, a connection control unit 230, and a terminal communication unit 240.

The NW communication unit 210 communicates with the network 400 side. The resource management unit 220 manages resources used in the wireless LAN base station 200, available resources, and the like, and grasps resources that can be provided to the terminal 100. The connection control unit 230 executes connection control on the basis of the communication quality requirement of the terminal 100, resources that can be provided to the terminal 100, and the like.

Moreover, the connection control unit 230 can grasp the communication quality actually provided for the terminal 100 in communication, and execute connection control on the basis of the communication quality requirement of the terminal 100 and the communication quality provided to the terminal 100. The terminal communication unit 240 performs wireless communication with the terminal 100.

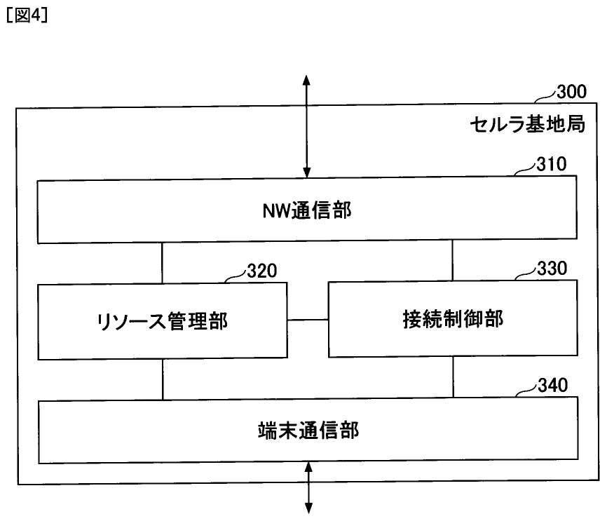

FIG. 4 illustrates a configuration example of the cellular base station 300. As illustrated in FIG. 4, the cellular base station 300 includes an NW communication unit 310, a resource management unit 320, a connection control unit 330, and a terminal communication unit 340.

The NW communication unit 310 communicates with the network 400 side. The resource management unit 320 manages resources used in the cellular base station 300, usable resources, and the like, and grasps resources that can be provided to the terminal 100. The connection control unit 330 executes connection control on the basis of the communication quality requirement of the terminal 100, resources that can be provided to the terminal 100, and the like.

Moreover, the connection control unit 330 can grasp the communication quality actually provided for the terminal 100 in communication, and execute connection control on the basis of the communication quality requirement of the terminal 100 and the communication quality provided to the terminal 100. The terminal communication unit 340 performs wireless communication with the terminal 100.

Hereinafter, Example 1-1 to Example 1-3 will be described as specific operation examples of a communication system according to Example 1. In Example 1-1 to Example 1-3, a situation is assumed in which a specific terminal 100 starts DL communication for use of an application in a state of being connected with the wireless LAN base station 200. Note that such an assumption is an example. For example, a similar operation can be performed even in a case where the UL communication is started. Moreover, the control indicated by the sequence is executed for each of the plurality of terminals, and the operation for the “terminal 100” will be described below as a representative.

Moreover, a similar operation can be performed even in a case of being not first connected with the wireless LAN base station 200 but first connected with the cellular base station 300. That is, in Example 1-1 to Example 1-3, a similar operation can be performed even if the wireless LAN base station 200 is replaced with the cellular base station 300 and the cellular base station 300 is replaced with the wireless LAN base station 200.

### Example 1-1

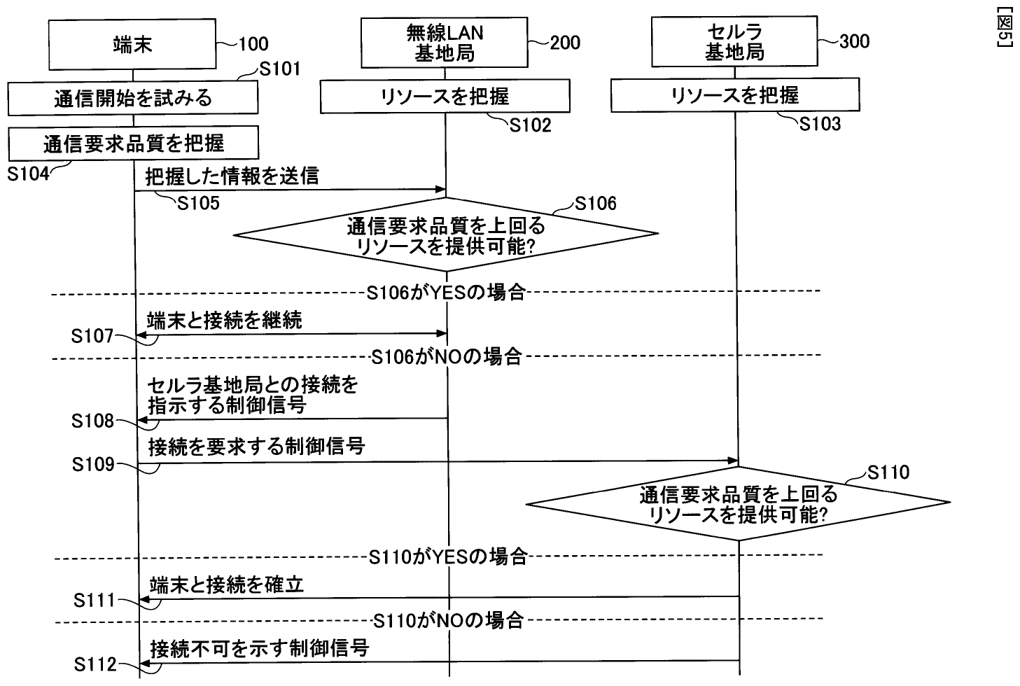

First, Example 1-1 will be described with reference to a sequence diagram of FIG. 5. In S101, the terminal 100 attempts to start communication for use of the application.

Moreover, the wireless LAN base station 200 constantly grasps resources that can be provided to the terminal 100 on the wireless LAN side on the basis of a communication status or the like of another terminal connected with the wireless LAN base station 200 itself (S102). Similarly, the cellular base station 300 constantly grasps resources which can be provided to the terminal 100 on the cellular system side on the basis of a communication status or the like of another terminal connected with the cellular base station itself (S103).

Resources that can be provided may be, for example, a band that can be provided to the terminal 100 in the path from the application server on the network 400 to the terminal 100, a time/frequency resource that can be allocated to the terminal 100 by the base station, communication quality (throughput, etc.) that can be provided, or other resources.

In S104, the terminal 100 grasps the communication quality requirement on the basis of the application or the like to be used. The communication quality requirement is, for example, a throughput necessary for use of an application. Moreover, the communication quality requirement varies depending on the use method of the application. For example, in a case where a video distribution application is used, the communication quality requirement is higher in a case where a high quality video is viewed than in a case where a low quality video is viewed.

In S105, the terminal 100 transmits the grasped information to the wireless LAN base station 200. In S106, the wireless LAN base station 200 determines whether the amount of resources that can be provided to the terminal 100 on the wireless LAN side is larger than the amount of resources that can satisfy the communication quality requirement of the terminal 100 or not. It is determined in S106 as Yes when the amount is larger, and it is determined in S106 as No when the amount is not larger (smaller). Specifically, for example, the wireless LAN base station 200 determines whether the throughput that can be provided to the terminal 100 is larger than the throughput requirement of the terminal 100 or not.

Note that the above determination method is an example. For example, the wireless LAN base station 200 may determines in S106 as Yes when “(communication quality that can be provided to terminal 100)/(communication quality requirement of terminal 100)” is X (0<X≤1) or more. X is a parameter set in advance. Moreover, X may be changed according to the congestion degree (e.g., the number of connected terminals) in the wireless LAN base station 200. Note that, in a case where the communication quality is a delay, the “communication quality” is calculated as “1/delay” in “(communication quality that can be provided to terminal 100)/(communication quality requirement of terminal 100)”. The same applies to what shows better communication quality as the value becomes smaller.

In a case where it is determined in S106 as Yes, the wireless LAN base station 200 continues the connection with the terminal 100 in S107.

In a case where it is determined in S106 as No, the wireless LAN base station 200 determines to connect the terminal 100 with the cellular base station 300, and transmits a control signal instructing connection with the cellular base station 300 to the terminal 100 in S108. Upon receiving the control signal, the terminal 100 transmits a control signal for requesting connection with the cellular base station 300 to the cellular base station 300 in S109. The communication quality requirement of the terminal 100 may be included in the control signal.

In S110, the cellular base station 300 determines whether the amount of resources that can be provided to the terminal 100 on the cellular system side is larger than the amount of resources that can satisfy the communication quality requirement of the terminal 100 or not. It is determined in S110 as Yes when the amount is larger, and it is determined in S110 as No when the amount is not larger. Specifically, for example, the cellular base station 300 determines whether the throughput that can be provided to the terminal 100 is larger than the throughput requirement of the terminal 100 or not.

Note that the above determination method is an example. For example, the cellular base station 300 may determines in S110 as Yes when “(communication quality providable to terminal 100)/(communication quality requirement of terminal 100)” is X (0<X≤1) or more. X is a parameter set in advance. X may be changed according to the congestion degree (e.g., the number of connected terminals) of the cellular base station 300.

In a case where it is determined in S110 as Yes, the cellular base station 300 establishes a connection with the terminal in S111. In a case where it is determined in S110 as No, the cellular base station 300 transmits a control signal indicating that the connection is impossible to the terminal 100 in S112. However, this is an example. For example, a connection may be established by notifying the terminal 100 that the communication request cannot be satisfied but the connection is established.

Moreover, in Example 1-1 (the same applies to Examples 1-2 and 1-3), similarly to the control in Example 3, the base station may monitor the communication quality during communication of the terminal 100, and may instruct the terminal 100 to switch the connection destination base station in a case where the communication quality requirement of the terminal 100 cannot be satisfied.

### Example 1-2

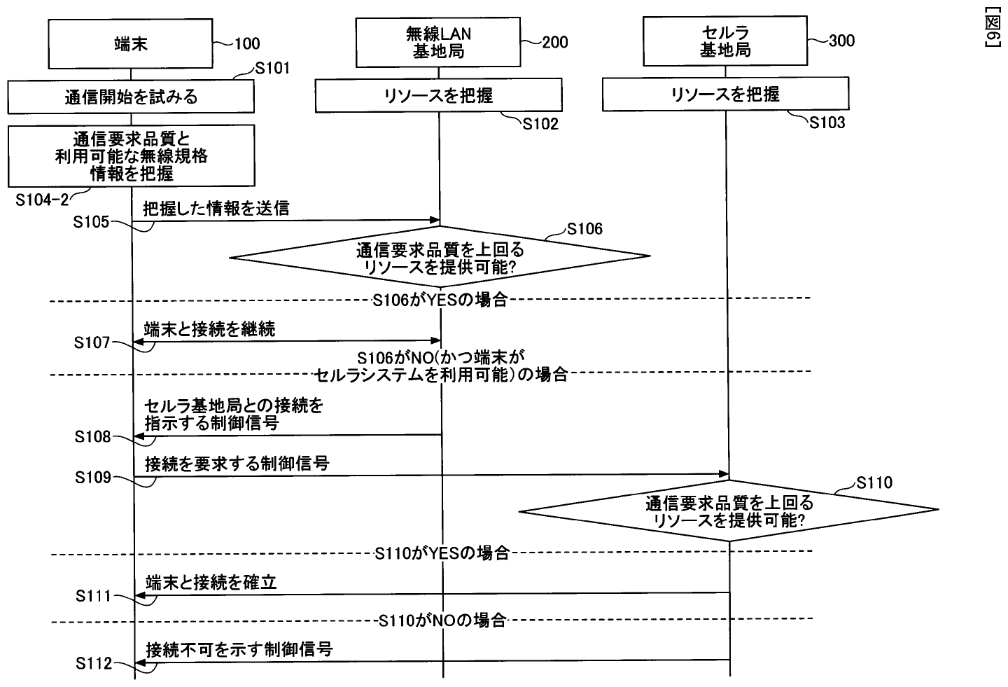

Next, Example 1-2 will be described with reference to FIG. 6. Since Example 1-2 is substantially the same as Example 1-1, only differences from Example 1-1 will be described.

After S101, the terminal 100 grasps wireless standard information available to the terminal 100 together with the communication quality requirement based on the use application or the like in S104-2. The wireless standard information is, for example, information indicating that a wireless LAN can be used, information indicating that a cellular system can be used, and the like. In S105, the terminal 100 notifies the wireless LAN base station 200 of available wireless standard information together with the communication quality requirement.

In a case where it is determined in S106 as No, the wireless LAN base station 200 refers to the wireless standard information available to the terminal 100, and transmits a control signal instructing connection with the cellular base station 300 to the terminal 100 in S108 in a case where the terminal 100 can use the cellular system. In a case where it is determined in S106 as No and the terminal 100 cannot use the cellular system, the wireless LAN base station 200 notifies the terminal 100 that the communication quality requirement is not satisfied, for example, and continues communication with the terminal 100.

### Example 1-3

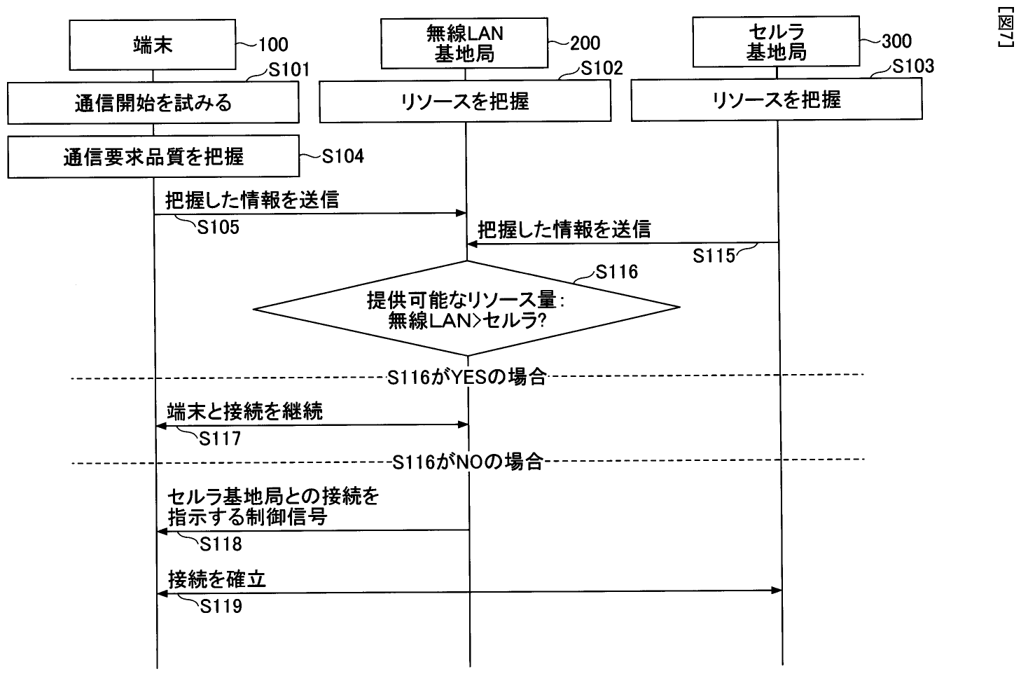

Next, Example 1-3 will be described with reference to FIG. 7. S101 to S105 are the same as those in Example 1-1. In S115, the wireless LAN base station 200 acquires, from the cellular base station 300, information on resources that can be provided by the cellular base station 300 to the terminal 100. Note that the exchange of information between the base stations may be performed directly between the base stations, may be performed via an NW controller or the like, or may be performed via a specific terminal.

In S116, the wireless LAN base station 200 determines whether the amount of resources that can be provided to the terminal 100 on the wireless LAN side is larger than the amount of resources that can satisfy the communication quality requirement of the terminal 100 or not, and determines whether the amount of resources that can be provided to the terminal 100 on the cellular system side is larger than the amount of resources that can satisfy the communication quality requirement of the terminal 100 or not.

Here, it is assumed that “the amount of resources that can be provided to the terminal 100 on the wireless LAN side is larger than the amount of resources that can satisfy the communication quality requirement of the terminal 100, and the amount of resources that can be provided to the terminal 100 on the cellular system side is larger than the amount of resources that can satisfy the communication quality requirement of the terminal 100” or “the amount of resources that can be provided to the terminal 100 on the wireless LAN side is smaller than the amount of resources that can satisfy the communication quality requirement of the terminal 100, and the amount of resources that can be provided to the terminal 100 on the cellular system side is smaller than the amount of resources that can satisfy the communication quality requirement of the terminal 100”.

In S116 in this situation, the wireless LAN base station 200 compares the amount of resources that can be provided to the terminal 100 on the wireless LAN side with the amount of resources that can be provided to the terminal 100 on the cellular system side, and determines whether the amount of resources that can be provided to the terminal 100 on the wireless LAN side is larger than the amount of resources that can be provided to the terminal 100 on the cellular system side or not. It is determined in S116 as Yes when the amount is larger, and it is determined in S116 as No when the amount is not larger (is smaller).

In a case where it is determined in S116 as Yes, the wireless LAN base station 200 continues the connection with the terminal 100 in S117.

In a case where it is determined in S116 as No, the wireless LAN base station 200 determines to connect the terminal 100 with the cellular base station 300, and transmits a control signal instructing connection with the cellular base station 300 to the terminal 100 in S118. In S119, the terminal 100 that has received the control signal establishes connection with the cellular base station 300.

Note that, in the case of “the amount of resources that can be provided to the terminal 100 on the wireless LAN side is smaller than the amount of resources that can satisfy the communication quality requirement of the terminal 100, and the amount of resources that can be provided to the terminal 100 on the cellular system side is smaller than the amount of resources that can satisfy the communication quality requirement of the terminal 100”, it is assumed here that communication can be continued although the amount of resources is smaller than the amount of resources that can satisfy the communication quality requirement of the terminal 100.

### Example 2

Next, Example 2 will be described. Example 2 is an example in which the NW controller 500 collects information from each base station and controls a connection destination of a terminal. Note that the NW controller may be referred to as an NW controller device.

<System Configuration Example>

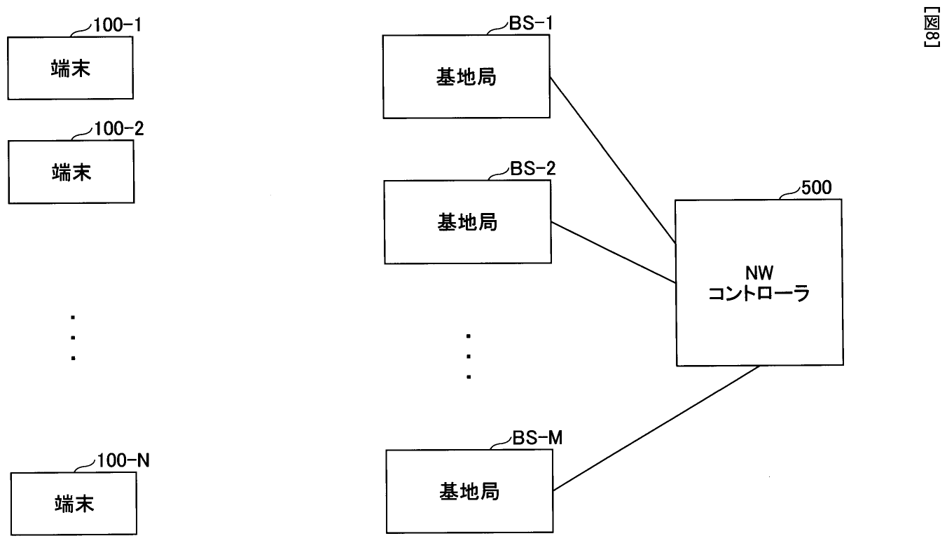

FIG. 8 illustrates an overall configuration example of a communication system according to Example 2. As illustrated in FIG. 8, the communication system includes a plurality of terminals 100-1 to 100-N, a plurality of base stations BS-1 to BS-M, and an NW controller 500. Each base station BS and the NW controller 500 are connected by wire or wirelessly. Note that, although not illustrated, each base station BS is also connected with a network 400 for data communication.

Each base station BS may be a wireless LAN base station, a cellular base station, or a base station of a scheme other than these.

In Example 2, the terminal 100 grasps its own communication quality requirement and transmits the information to the NW controller 500 via any of the base stations BS. The NW controller 500 grasps resources that can be provided by each base station BS, and selects an optimal base station BS to be connected with each terminal 100 on the basis of the communication quality requirement of the terminal 100.

The configuration of the terminal 100 is similar to the configuration illustrated in FIG. 2 in Example 1. The base station BS in Example 2 may be configured to be able to transmit resource information to the NW controller 500 and operate according to an instruction from the NW controller 500. Moreover, the base station BS in Example 2 may have a configuration similar to the configuration illustrated in FIGS. 3 and 4 in Example 1.

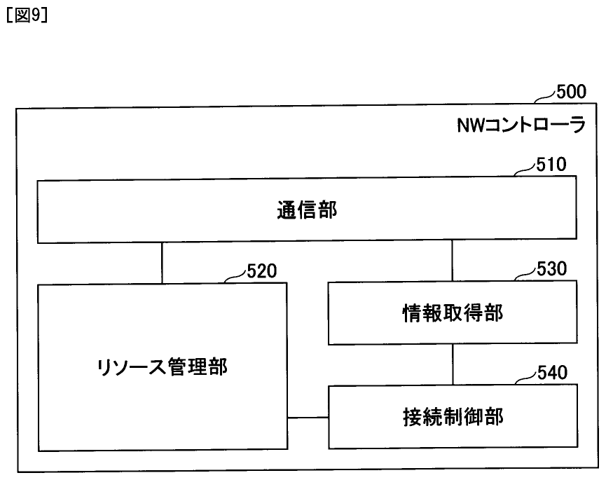

FIG. 9 illustrates a configuration diagram of an NW controller 500. As illustrated in FIG. 9, the NW controller 500 includes a communication unit 510, a resource management unit 520, an information acquisition unit 530, and a connection control unit 540.

The communication unit 510 communicates with each base station BS. The information acquisition unit 530 collects information from each terminal and each base station BS. Moreover, the information acquisition unit 530 acquires (monitors) the actual communication quality of the terminal in communication.

The resource management unit 520 manages resources being used, an available resource, and the like for each terminal in each base station BS on the basis of information collected from each terminal and each base station BS. The connection control unit 540 performs control such as determination and switching of the connection destination base station of the terminal on the basis of the communication quality requirement of the terminal, the resource that can be provided to the terminal, the communication quality actually provided to the terminal, and the like.

<Operation Example>

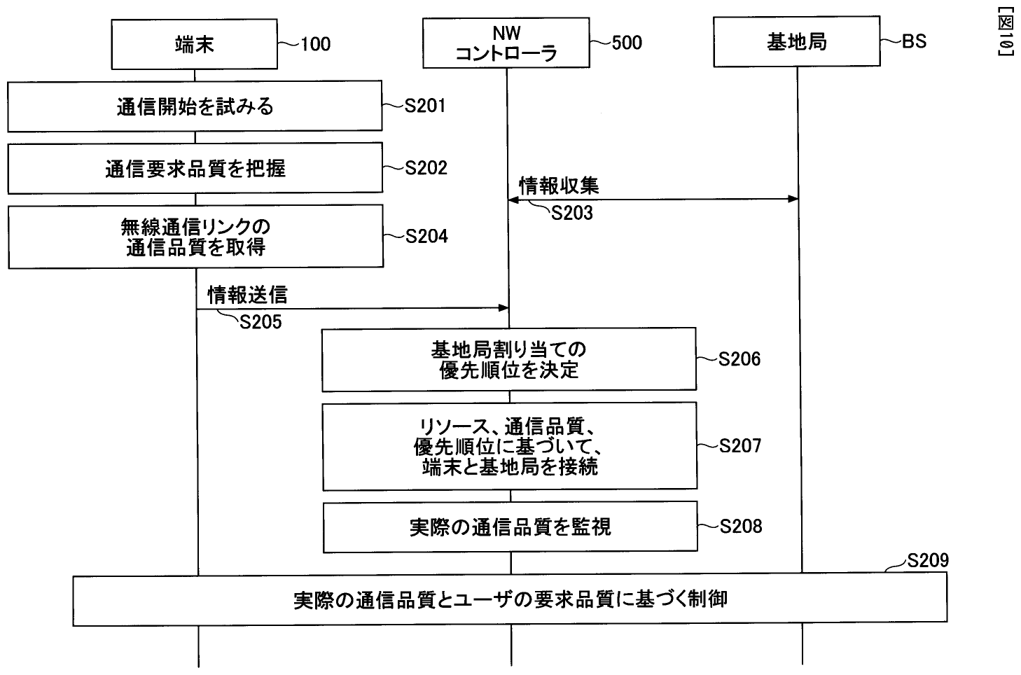

Next, an operation example of the communication system according to Example 2 will be described with reference to a sequence diagram of FIG. 10. Regarding the terminal, note that, although FIG. 10 illustrates the operation of one terminal 100, this is for convenience of illustration, and actually a plurality of terminals respectively perform similar operations as the terminal 100 at arbitrary timing. Moreover, regarding the base station BS, although a plurality of base stations BS actually exist, one base station BS is illustrated in FIG. 10.

Moreover, as a premise of FIG. 10, it is assumed that the terminal 100 is in a state of not being connected with a base station BS for use of the application, but can communicate with a certain base station BS for transmission of feedback information.

In S201, the terminal 100 attempts to start communication for use of the application.

In S202, the terminal 100 grasps the communication quality requirement on the basis of the application or the like to be used. The communication quality requirement is, for example, a throughput necessary for use of an application. Moreover, the communication quality requirement may vary depending on the use method of the application. For example, in a case where a video distribution application is used, the communication quality requirement is higher in a case where a high quality video is viewed than in a case where a low quality video is viewed.

As illustrated in S203, the NW controller 500 constantly (e.g., periodically) collects information such as a communication status of each terminal connected with each base station BS, information on resources that can be provided by each base station, and the like from each base station BS. The NW controller 500 can grasp resources that can be provided to the terminal 100 for each base station BS on the basis of the collected information.

In S204, the terminal 100 acquires the communication quality (e.g., RSSI, RSRQ, etc.) of a wireless communication link with each base station BS on the basis of the signal strength of the received power of the signal from surrounding wireless devices (all base stations BS+ all other terminals) and the like.

In S205, the terminal 100 transmits (feeds back) the information acquired in S202 and S204 to the NW controller 500 via any of the base stations BS.

In S206, the NW controller 500 determines the priority order of allocating the base station BS regarding the terminal requesting the communication (connection) and terminals connected with the base station BS. For example, the priority order may be determined corresponding to the order of connection requests. Moreover, the priority order may be determined according to the priority of the terminal included in the information collected from the terminal.

For example, in a case where the priority of a certain terminal that has been connected with the base station BS and is communicating with the base station BS is higher than the priority of another terminal requesting communication, control of connection switching (switching to a base station BS that provides high-quality communication, etc.) in the connected terminal is executed with priority over connection control of the another terminal.

It is assumed that the control target terminal is determined as the terminal 100 on the basis of the priority order. The NW controller 500 calculates the communication quality that can be provided to the terminal 100 in each base station BS from the communication quality of the wireless communication link in the terminal 100 for each base station BS and a resource that can be provided to the terminal 100 in each base station BS on the basis of the collected information. Note that, also in Example 1, the communication quality that can be provided to the terminal 100 by the base station may be calculated from the communication quality of the wireless communication link in the terminal 100 for the base station and the resource that can be provided to the terminal 100 in the base station when the base station determines a resource that can be provided to the terminal 100.

The NW controller 500 compares the communication quality requirement of the terminal 100 with the communication quality that can be provided to the terminal 100 in each base station BS, and selects the base station BS capable of providing the communication quality satisfying the communication quality requirement of the terminal 100. In a case where a plurality of base stations BS capable of providing a communication quality satisfying the communication quality requirement of the terminal 100 exist, one base station BS is selected from the plurality of base stations BS. As an example, a base station BS having the maximum RSSI in the terminal 100 may be selected from the plurality of base stations BS capable of providing a communication quality satisfying the communication quality requirement of the terminal 100.

The NW controller 500 connects the selected base station BS and the terminal 100. For example, the NW controller 500 instructs the terminal 100 to connect with the selected base station BS via any of the base stations BS. Alternatively, the NW controller 500 may instruct the selected base station BS to connect with the terminal 100.

In S208, the NW controller 500 grasps the communication quality of the communication executed by the terminal 100. For example, the NW controller 500 monitors a data packet, a throughput, an RTT, and the like of communication executed by the terminal 100 on the basis of data obtained from a network device (which may be the selected base station BS) through which communication executed by the terminal 100 passes.

In S209, the NW controller 500 executes control based on the actual communication quality grasped in S208 and the communication quality requirement of the terminal 100. For example, the NW controller 500 determines whether the actual communication quality is higher than the communication quality requirement of the terminal 100 or not, and in a case where the actual communication quality is higher, the NW controller 500 waits for a predetermined time (e.g., Y time slots) and again determines whether the actual communication quality is higher than the communication quality requirement of the terminal 100 or not. In a case where a state in which the actual communication quality is higher than the communication quality requirement of the terminal 100 continues, the above-described standby/determination is repeated until the end of the communication.

In the above determination, in a case where the actual communication quality is not higher than the communication quality requirement of the terminal 100, for example, in a case where the actual throughput is lower than the throughput required by the terminal 100, the NW controller 500 instructs the terminal 100 to grasp the communication quality of the wireless communication link via any of the base stations BS. Thereafter, the processing from S205 in FIG. 10 is performed again. In a case where another base station BS different from the connected base station BS is selected as the base station BS for the terminal 100 in the second time S207, connection switching to the another base station BS is performed.

For the above Y (the number of waiting time slots), as described above, for example, quality degradation can be quickly detected by grasping the quality in a short period in a case where the quality requirement of the user is high, and communication quality degradation to some extent is regarded as an allowable range and the communication quality is grasped in a relatively long period in a case where the quality requirement of the user is low.

### Example 3

Next, Example 3 will be described. In Example 3, an example of an evaluation procedure of a satisfaction level (or sufficiency level) of the user will be described. Although the operation of Example 3 may be performed in the base station BS (may be performed in a wireless LAN base station or a cellular base station) or may be performed in the NW controller 500, the operation will be described as being performed by the NW controller 500 (specifically, the connection control unit 540) as an example. The operation described below may be performed by the connection control unit of the base station BS.

Hereinafter, Examples 3-1 to 3-3 will be described. In any of Examples 3-1 to 3-3, a plurality of terminals that are connected with one or a plurality of base stations BS and perform communication exist, and the satisfaction level/sufficiency level of each terminal is calculated.

### Example 3-1

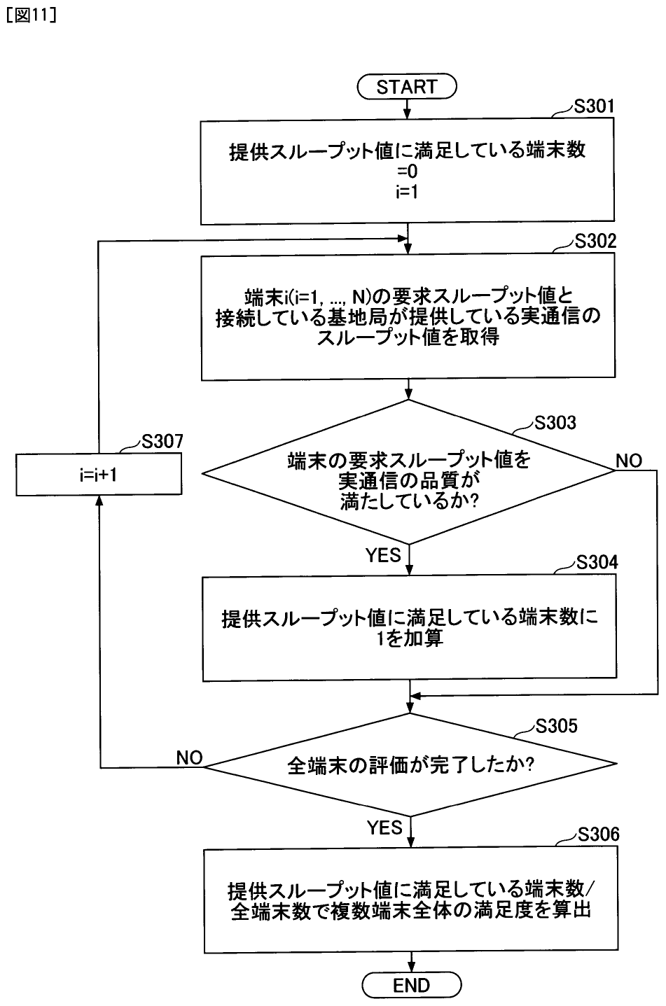

In Example 3-1, whether the quality of actual communication performed by the terminal satisfies the requirement of the user (terminal) or not (this is referred to as “satisfaction level”) is evaluated for each terminal. A processing procedure executed by the NW controller 500 in Example 3-1 will be described with reference to FIG. 11. Moreover, a throughput is also used as an example of quality. In FIG. 11, N is the total number of terminals. The total number of terminals may be the number of terminals connected with one specific base station BS, or may be the total number of terminals communicating with any of the base stations BS.

In S301, the NW controller 500 initializes the number of terminals satisfied with the provided throughput value to 0 and initializes i to 1.

In S302, the NW controller 500 acquires the required throughput value of a terminal i (i=1, . . . , N) and the throughput value of actual communication provided by a base station BS connected with the terminal i.

In S303, the NW controller 500 determines whether the throughput value of actual communication satisfies the required throughput value of the terminal i or not. That is, whether “throughput value of actual communication required throughput value” is satisfied or not is determined.

The process proceeds to S304 when it is determined in S303 as Yes (satisfied), or the process proceeds to S305 when it is determined as No (not satisfied).

In S304, 1 is added to the number of terminals satisfied with the provided throughput value. In S305, the NW controller 500 determines whether the evaluation of all the terminals has been completed or not, and the process proceeds to S307 when it is determined as No, or the process proceeds to S306 when it is determined as Yes. In S307 corresponding to the case of No, the process from S302 is repeated with i=i+1.

In S306, the NW controller 500 calculates “the number of terminals satisfied with the provided throughput value/the total number of terminals” to calculate the satisfaction levels of all the plurality of terminals, and terminates the processing.

The above processing is executed periodically, for example. In the satisfaction level determination of each terminal being processed, switching control of the connection destination base station BS may be performed for a terminal that is not satisfied, as described in Example 3.

Moreover, for example, assuming that “all terminals” in FIG. 11 are terminals to be connected with one base station BS, the processing illustrated in FIG. 11 may be performed for each base station BS. In this case, the NW controller 500 may select the connection destination base station BS for a certain terminal according to the satisfaction levels for all the terminals calculated in S306 for each base station BS. For example, a connection destination base station BS of the terminal may be selected from the base stations BS having satisfaction levels for all the terminals equal to or higher than a certain threshold.

### Example 3-2

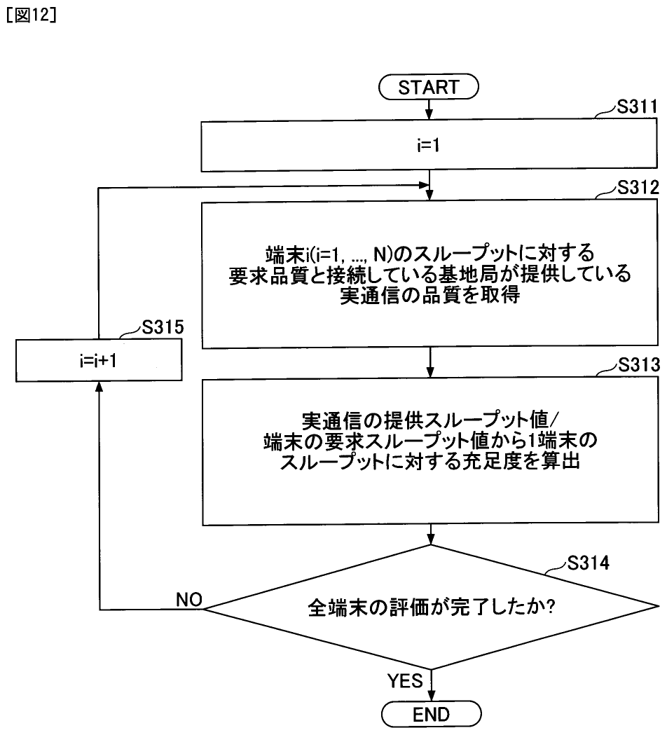

In Example 3-2, the degree of how much the quality of actual communication performed by a terminal satisfies the requirement of the user (terminal) (this is referred to as “sufficiency level”) is evaluated for each terminal. A processing procedure executed by the NW controller 500 in Example 3-2 will be described with reference to FIG. 12. Moreover, a throughput is also used as an example of quality. In FIG. 12, N is the total number of terminals.

The total number of terminals may be the number of terminals connected with one specific base station BS, or may be the number of terminals communicating with any of the base stations BS.

In S311, the NW controller 500 initializes i to 1. In S312, the NW controller 500 acquires a quality requirement for the throughput of a terminal i (i=1 . . . , N) and the quality of actual communication provided by a base station BS connected with the terminal i.

In S313, the NW controller 500 calculates the sufficiency level for the throughput of the terminal i from “provided throughput value of actual communication/required throughput value of terminal”.

In S314, the processing is terminated in a case where the evaluation of all the terminals has been completed, or the processing from S312 is executed with i=i+1 in S315 in a case where the evaluation has not been completed.

The above processing is executed periodically, for example. In the sufficiency level determination of each terminal being processed, for example, switching of the connection destination base station BS may be performed for a terminal for which the sufficiency level is equal to or lower than a threshold as described in Example 3.

### Example 3-3

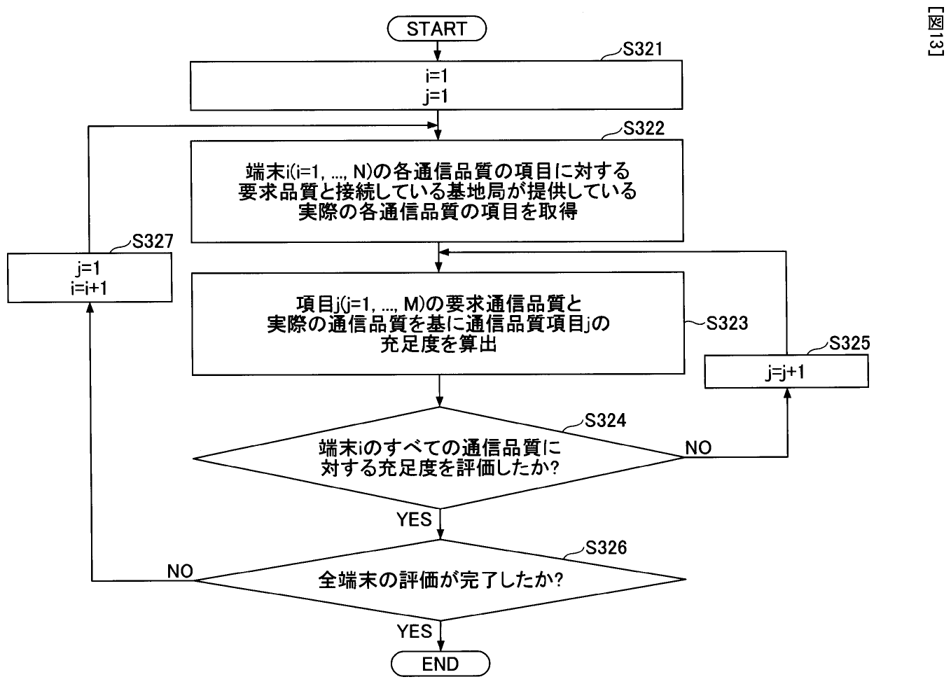

In Example 3-3, the degree of how much the quality of actual communication performed by a terminal satisfies the requirement of the user (terminal) (this is referred to as “sufficiency level”) is evaluated for each terminal for each quality. A processing procedure executed by the NW controller 500 in Example 3-3 will be described with reference to FIG. 13. In FIG. 13, N is the total number of terminals. The total number of terminals may be the number of terminals connected with one specific base station BS, or may be the number of terminals communicating with any of the base stations BS. Moreover, M is the number of communication quality items.

In S321, the NW controller 500 performs initialization with i=1 and j=1. In S322, the NW controller 500 acquires a quality requirement for an item of each communication quality of a terminal i (i=1, . . . , N), and the actual communication quality of each item provided by the base station BS connected with the terminal i.

In S323, the NW controller 500 calculates the sufficiency level of the communication quality item j on the basis of the communication quality requirement of the item j (j=1, . . . , M) and the actual communication quality.

A method of calculating the sufficiency level is set in advance for each communication quality. For example, the sufficiency level is calculated by “throughput sufficiency level=provided throughput value/required throughput value”, “delay sufficiency level=required delay value/provided delay value”, or the like.

The process proceeds to S326 in a case (case of Yes) where the sufficiency levels for all the communication qualities of the terminal i have been evaluated in S324, or the process proceeds to S325 in the case of No. In S325, processing from S323 is performed with j=j+1.

In S326, the processing is terminated in a case where the evaluation of all the terminals has been completed, or the processing from S322 is executed with i=i+1 in S327 in a case where the evaluation has not been completed.

The above processing is executed periodically, for example. In the sufficiency level determination of each terminal being processed, for example, in a case where the sufficiency level of the quality of a specific item is equal to or lower than a predetermined threshold value for a certain terminal, switching of the connection destination base station BS may be performed for the terminal as described in Example 3. The specific item may be an item designated by the terminal.

Moreover, a weight αⱼ may be assigned to each item j, and switching of the connection destination base station BS may be performed for a terminal having a weighted sum (Σ sufficiency level j×αⱼ) equal to or smaller than a predetermined threshold value as described in Example 3.

(Hardware Configuration Example)

The terminal 100, the base station BS (including a wireless LAN base station and a cellular base station), and the NW controller 500 can all be implemented by, for example, causing a computer to execute a program. This computer may be a physical computer, or may be a virtual machine in a cloud. The terminal 100, the base station BS (including a wireless LAN base station and a cellular base station), and the NW controller 500 are collectively referred to as “devices”.

That is, the device can be implemented by executing a program corresponding to processing performed by the device using hardware resources such as a CPU and a memory built in the computer. The above program can be recorded on a computer-readable recording medium (portable memory, etc.), and be stored or distributed. Moreover, the above program can also be provided through a network such as the Internet or an electronic mail.

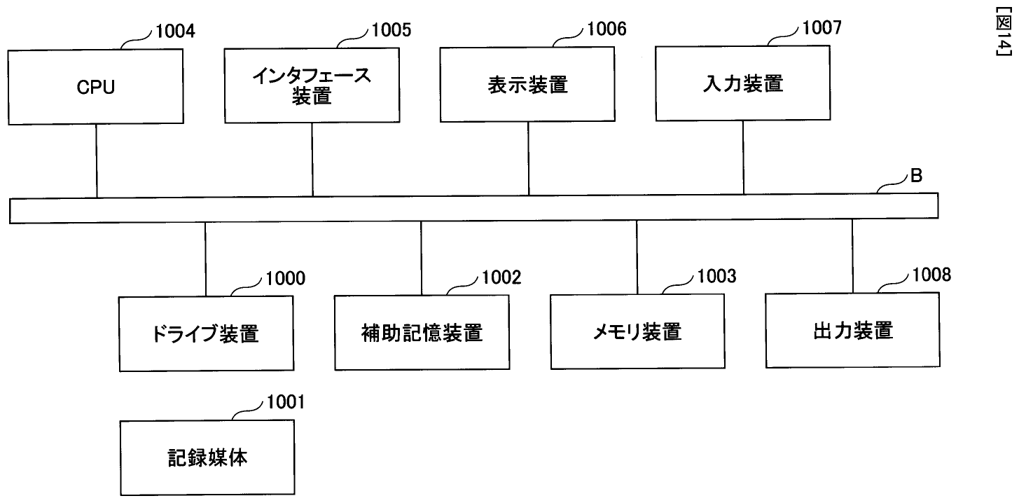

FIG. 14 is a diagram illustrating a hardware configuration example of the above computer. The computer in FIG. 14 includes a drive device 1000, an auxiliary storage device 1002, a memory device 1003, a CPU 1004, an interface device 1005, a display device 1006, an input device 1007, an output device 1008, and the like that are connected with each other by a bus BS. Note that some of these devices are not necessarily included. For example, in a case where display is not to be performed, the display device 1006 may not be included.

The program for implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads and stores the program from the auxiliary storage device 1002. The CPU 1004 implements a function related to the device in accordance with a program stored in the memory device 1003. The interface device 1005 is used as an interface for connection with a network, and functions as a transmission unit and a reception unit. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result.

(Regarding Effects of Embodiment)

With the technology according to this embodiment described above, it is possible to provide a communication quality satisfying the requirement of the terminal. Moreover, for example, connection with the cellular base station can be controlled in a case where resources of the wireless LAN base station are depleted, and thus, the number of terminals provided with satisfactory communication quality increases as compared with a conventional method.

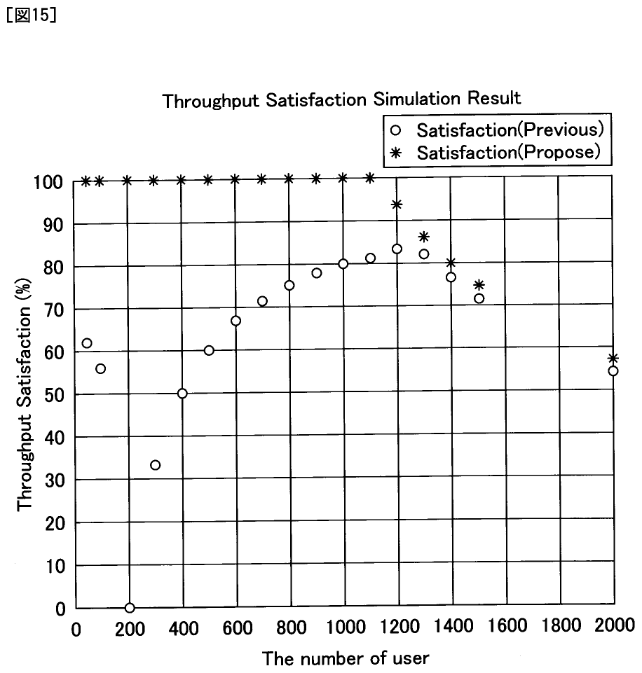

FIG. 15 is a diagram of a simulation result illustrating a relationship between the number of users (the number of terminals) and the proportion of the satisfactory terminals among all the terminals in a conventional method (Previous) and the present proposal (Propose) in a case where the throughput is used as the communication quality. As illustrated in FIG. 15, it can be seen that the number of terminals provided with satisfactory communication quality increases as compared with the conventional method.

(Summary of Embodiment)

The present specification discloses at least a wireless communication system, a base station device, an NW control device, and a connection control method described in each of the following clauses.

(Clause 1)

A wireless communication system including a plurality of base station devices including a first base station device and a second base station device,
in which the first base station device connected with a terminal determines whether to continue connection with the terminal or not on the basis of a communication quality requirement of the terminal and a resource that can be provided to the terminal, and
the first base station device transmits a control signal instructing connection with the second base station device to the terminal in a case where the first base station device determines not to continue the connection with the terminal.

(Clause 2)

The wireless communication system according to clause 1,
in which the first base station device transmits a control signal instructing connection with the second base station device to the terminal in a case where the first base station device determines not to continue the connection with the terminal and determines that the terminal can use the second base station device on the basis of information received from the terminal.

(Clause 3)

A wireless communication system including a plurality of base station devices and an NW controller device,
in which the NW controller device receives a communication quality requirement from a terminal and receives information on a resource that can be provided from each base station device, and
the NW controller device selects a base station device capable of providing the communication quality requirement on the basis of the communication quality requirement of the terminal and a resource that can be provided to the terminal in each base station device, and connects the terminal with the selected base station device.

(Clause 4)

The wireless communication system according to clause 3,
in which the NW controller device executes connection control of the terminal on the basis of a communication quality provided to the terminal by the selected base station device and the communication quality requirement.

(Clause 5)

A base station device in a wireless communication system including a plurality of base station devices, the base station device including:
means for determining whether to continue connection with the terminal or not on the basis of a communication quality requirement of a terminal connected with the base station device and a resource that can be provided to the terminal; and
means for transmitting a control signal instructing connection with another base station device to the terminal when determining not to continue the connection with the terminal.

(Clause 6)

An NW controller device in a wireless communication system including a plurality of base station devices and the NW controller device, the NW controller device including:
means for receiving a communication quality requirement from a terminal and receiving information on a resource that can be provided from each base station device; and
means for selecting a base station device capable of providing the communication quality requirement on the basis of the communication quality requirement of the terminal and a resource that can be provided to the terminal in each base station device, and connecting the terminal with the selected base station device.

(Clause 7)

A connection control method executed in a wireless communication system including a plurality of base station devices including a first base station device and a second base station device, the connection control method including:
a step of determining, by the first base station device connected with a terminal, whether to continue connection with the terminal or not on the basis of a communication quality requirement of the terminal and a resource that can be provided to the terminal; and
a step of transmitting a control signal instructing connection with the second base station device to the terminal in a case where the first base station device determines not to continue the connection with the terminal.

(Clause 8)

A connection control method executed in a wireless communication system including a plurality of base station devices and an NW controller device, the connection control method including:
a step of receiving, by the NW controller device, a communication quality requirement from a terminal and receiving information on a resource that can be provided from each base station device; and
a step of selecting, by the NW controller device, a base station device capable of providing the communication quality requirement on the basis of the communication quality requirement of the terminal and a resource that can be provided to the terminal in each base station device, and connecting the terminal with the selected base station device.

Although this embodiment has been described above, the present invention is not limited to such a specific embodiment, and various modifications and changes can be made within the scope of the gist of the present invention described in the claims.

### REFERENCE SIGNS LIST

100-1 to 100-N Terminal
110 Communication unit
120 Information acquisition unit
130 Data storage unit
140 Measurement unit
200 Wireless LAN base station
210 NW communication unit
220 Resource management unit
230 Connection control unit
240 Terminal communication unit
300 Cellular base station
310 NW communication unit
320 Resource management unit
330 Connection control unit
340 Terminal communication unit
BS-1 to BS-M Base station
400 Network
500 NW controller
510 Communication unit
520 Resource management unit
530 Information acquisition unit
540 Connection control unit
1000 Drive device
1001 Recording medium
1002 Auxiliary storage device
1003 Memory device
1004 CPU
1005 Interface device
1006 Display device
1007 Input device
1008 Output device

1. A wireless communication system comprising:
a plurality of base station devices including a first base station device and a second base station device,
wherein the first base station device connected with a terminal determines whether to continue connection with the terminal or not on a basis of a communication quality requirement of the terminal and a resource that can be provided to the terminal, and
when the first base station device determines not to continue the connection with the terminal, the first base station device transmits a control signal, wherein the control signal instructs connection with the second base station device to the terminal.

2. The wireless communication system according to claim 1,
wherein, when the first base station device determines not to continue the connection with the terminal and determines that the terminal can use the second base station device on a basis of information received from the terminal, the first base station device transmits a control signal instructing connection with the second base station device to the terminal.

3. A wireless communication system comprising:
a plurality of base station devices and a network (NW) controller device,
wherein the NW controller device receives a communication quality requirement from a terminal and receives information on a resource that can be provided from each base station device of the plurality of base station devices, and
the NW controller device selects a base station device of the plurality of base station devices, the base station device is capable of providing the communication quality requirement on a basis of the communication quality requirement of the terminal and the resource that can be provided to the terminal in each base station device of the plurality of base station devices, and connects the terminal with the selected base station device.

4. The wireless communication system according to claim 3,
wherein the NW controller device executes connection control of the terminal on a basis of communication quality provided to the terminal by the selected base station device according to the communication quality requirement.

5. A base station device of a plurality of base station devices in a wireless communication system, the base station device comprising a processor configured to execute operations comprising:
determining whether to continue connection with a terminal or not on a basis of a communication quality requirement of the terminal connected with the base station device and a resource that can be provided to the terminal; and
when determining not to continue the connection with the terminal, transmitting a control signal instructing connection with another base station device of the plurality of base station devices to the terminal.

6-8. (canceled)

9. The wireless communication system according to claim 1, wherein the communication quality requirement includes at least one of:
a first communication quality associated with a downlink communication,
a second communication quality associated with an uplink communication,
a third communication quality associated with a wireless communication link between the terminal and the first base station device,
a fourth communication quality associated with the first base station device, or a priority of controlling a plurality of terminals that perform communication, the plurality of terminals includes the terminal.

10. The wireless communication system according to claim 1, wherein the resource includes a network band associated with a network path from an application server to the terminal.

11. The wireless communication system according to claim 1, wherein the resource includes a time/frequency resource allocated to the terminal by the first base station device.

12. The wireless communication system according to claim 3, wherein the communication quality requirement includes at least one of:
a first communication quality associated with a downlink communication,
a second communication quality associated with an uplink communication,
a third communication quality associated with a wireless communication link between the terminal and the base station device of the plurality of base station devices,
a fourth communication quality associated with the base station device of the plurality of base station devices, or
a priority of controlling a plurality of terminals that perform communication, the plurality of terminals includes the terminal.

13. The wireless communication system according to claim 3, wherein the resource includes a network band associated with a network path from an application server to the terminal.

14. The wireless communication system according to claim 3, wherein the resource includes a time/frequency resource allocated to the terminal by the base station device of the plurality of base station devices.

15. The base station device according to claim 5, wherein, when the base station device of the plurality of base station devices determines not to continue the connection with the terminal and determines that the terminal can use said another base station device of the plurality of base station devices on a basis of information received from the terminal, the base station device of the plurality of base station devices transmits a control signal instructing connection with said another base station device of the plurality of base station devices to the terminal.

16. The base station device according to claim 5, wherein the communication quality requirement includes at least one of:
a first communication quality associated with a downlink communication,
a second communication quality associated with an uplink communication,
a third communication quality associated with a wireless communication link between the terminal and the base station device of the plurality of base station devices,
a fourth communication quality associated with the base station device of the plurality of base station devices, or
a priority of controlling a plurality of terminals that perform communication, the plurality of terminals includes the terminal.

17. The base station device according to claim 5, wherein the resource includes a network band associated with a network path from an application server to the terminal.

18. The base station device according to claim 5, wherein the resource includes a time/frequency resource allocated to the terminal by the base station device of the plurality of base station devices.
